(19) United States
(12) Patent Application Publication
(10) Pub. No.: US 2002/0025000 A1
(43) Pub. Date: Feb. 28, 2002

(54) Method of transcoding and apparatus of transcoding for video coded bitstream

(75) Inventors: Seiichi Takeuchi, Osaka (JP); Masakazu Nishino, Osaka (JP)

Correspondence Address: MCDERMOTT, WILL & EMERY, 600 13th Street, N.W., Washington, DC, 20005-3096, US

(73) Assignee: Matsushita Electric Industrial Co., Ltd.

(21) Appl. No.: 09/897,039

(22) Filed: Jul. 3, 2001

(30) Foreign Application Priority Data
May 7, 2000 (JP) 2000-203143

(51) Int. Cl. H04N 7/12

(52) U.S. Cl. 375/240.12; 375/240.2; 375/240.24

(57) ABSTRACT

The invention reduces a quantity of relevant codes without decoding coded data in a bitstream of an image signal, etc. to the image signal. Processing for the code quantity reducing method is performed according to such a simple rule that leaves as it is only one coefficient encountered first in scanning, that leaves only a DC coefficient, that transcodes all DCT coefficients to “0” while changing an MBT, or that transcodes all DCT coefficients to “0” while changing a CBP. Also, in principle, one coefficient is left as is or the MBT or CBP is changed, so that there is no need to update an address counter because of generation of an SMB. Even a low-throughput processing unit employed, it is possible to realize on a real-time basis the bitstream transcoding processing accompanied by reduction of the code quantity. The costs can also be reduced for the provision such as an image distribution system.

### BACKGROUND OF THE INVENTION

1. Field of the Invention

The invention relates to a method and an apparatus for reducing the quantity of codes contained in a bitstream of, e.g. an image signal coded according to the MPEG (Moving Picture Experts Group) standard. More specifically, the invention relates to a method and an apparatus for meeting a standard specification of a bitstream of a subject image signal yet reducing the quantity of codes without decoding the coded data.

2. Description of the Related Art

As the moving image coding method are known such MPEG standards as MPEG1 (ISO/IEC11172), MPEG2 (ISO/IEC13818-2), MPEG4 (ISO/IEC14496-2), etc.

An image distribution system stores on a transmission side a coded moving picture image bitstream obtained by the MPEG standard to then distribute the bitstream to a reception side. If a relevant transmission band width is not sufficient, the system transmits the bitstream in a reduced quantity of the codes.

There is such a method available that calculates a target bit rate for each picture and also determines a target bit rate for each DCT block (or a macro block (MB)) based on the number of DCT blocks to be transcoded, thus reducing a value of a DCT coefficient for each of the blocks so as to realize the target bit rate. DCT stands for Discrete Cosine Transcode.

This method, however, must execute such processes according to complicated rules as (1) calculation of a target bit rate for each picture, (2) calculation of a target bit rate for each DCT block (or MB), (3) constant monitoring of a generated bit rate, (4) comparison and determination of a generated bit rate and a target bit rate, and (5) changing of a processing method based on a decision result. Also, this method sometimes needs to greatly change flags in bitstreams in order to conduct high accuracy control on an output bit rate.

The changing of flags in bitstreams means as follows. In a P picture using forward prediction, in a case where a macro block type (MBT), which is a coded type of an MB, “includes a block accompanied by motion-less (motion vector is “0”) motion compensation and having a DCT coefficient” (No MC, Coded), when the DCT coefficients are all set to “0”, the relevant MB will be a skip macro block (SMB), thus eliminating the generated codes. Then, while deciding whether an MB following this MB is also an SMB, the processing changes an address counter of a next MB in which a generated code is present. Such processing refers to changing of a flag.

The above-mentioned method is accompanied by processing according to complicated rules and by changing of flags and therefore requires high-throughput processing unit (CPU, DSP, etc.) in order to execute bitstream transcode on a real time basis accompanied by reduction of a quantity of codes.

### SUMMARY OF THE INVENTION

In view of the above, it is an object of the invention to provide a bitstream transcoding method that can reduce the quantity of codes of a bitstream of an image signal to thereby reduce the quantity of the coded data without executing processing according to complicated rules. The invention provides also a method and an apparatus that permit even a low-throughput processing unit to execute on a real-time basis such bitstream transcode processing that is accompanied by reduction of the quantity of codes.

By the invention, without decoding coded data in a bitstream of an image signal etc., the quantity of the codes is reduced. A method for specifically reducing the quantity of the codes is to execute processing according to simple rules. That is, no processing according to complicated rules such as those of the above-mentioned prior art is performed.

(1) The bitstream transcoding method according to the invention comprises the steps of: analyzing a data structure of a bitstream to be input to thereby detect whether a relevant DCT block contains a DCT coefficient in a macro block; leaving only one “non-zero” coefficient encountered in scanning in the above-mentioned detected DCT block having the DCT coefficient to then transcode all the other DCT coefficients to “0”; and outputting a bitstream having a quantity of codes that is reduced by the above-mentioned transcoding step. In this case, without decoding the coded data in the bitstream, the quantity of the codes is reduced. In such a case, “transcoding all to ‘0’” means to “transcode ‘non-zero’ coefficients to ‘0’, leaving the originally ‘0’ coefficients unchanged.” This holds true hereinafter also.

The processing according to such a simple rule as leaving only one “non-zero” coefficient encountered first in scanning can reduce the quantity of codes. Despite of this reduction, one coefficient is left, thus generating no SMB in which the DCT coefficients are all “0”. Therefore, there is no need to update the address counter because of generation of an SMB.

Also, by employing processing according to simple rules, even a low-throughput processing unit employed can execute, on a real-time basis, bitstream processing accompanied by reduction of the quantity of codes. No high-grade processing unit needs to be mounted, thus enabling reducing the costs in a provision such as an image distribution system.

(2) Also, the bitstream transcoding method according to the invention comprises the steps of: analyzing a data structure of a bitstream to be input to thereby detect whether a relevant DCT contains a DCT coefficient in an inter-macro block accompanied by reduction of a quantity of codes; leaving only DC coefficients in that detected DCT block containing that DCT coefficient in the inter-macro block to thereby transcode all the other AC coefficients to “0”; and outputting a bitstream having such a quantity of codes as reduced by the above-mentioned transcode step. In the case of the MPEG standard, an Inter MB accompanied by predictive coding corresponds to a P picture or a B picture. In comparison to (1) above, the “non-zero” coefficient encountered first in scanning corresponds to a DC coefficient.

In the above, in a preferred aspect, when the above-mentioned DC coefficient is “0”, as the above-mentioned coefficient to be left, a prescribed AC coefficient is assigned. Accordingly, when the DC coefficient is “0”, the DCT coefficients are all transcoded to “0”, thus avoiding generation of an SMB.

(3) Also, the bitstream transcoding method according to the invention comprises the steps of: analyzing a data structure of a bitstream to be input to thereby whether a relevant DCT block contains a DCT coefficient in an intra-macro block not accompanied by predictive coding; leaving only the DC coefficient in the above-mentioned detected DCT block containing the DCT coefficient in the intra-macro block (Intra MB) to thereby transcode all the other AC coefficients to “0”; and outputting a bitstream having such a quantity of codes as reduced by the above-mentioned transcode step.

(4) Also, the bitstream transcoding method according to the invention comprises the steps of: analyzing a data structure of a bitstream to be input to thereby detect whether a relevant DCT block contains a DCT coefficient in a macro block; leaving only first through N'th coefficients in a scanning order (N: natural number) to thereby transcode all the other DCT coefficients to “0”; and outputting a bitstream having such a quantity of codes as reduced by the above-mentioned transcode step.

In the above, in a preferred aspect, if the first through N'th DCT coefficients as encountered in the above-mentioned scanning are all “0”, a prescribed AC coefficient is assigned as the above-mentioned coefficient to be left. This prevents the DCT coefficients from being transcoded all to “0”, thus preventing generation of an SMB.

(5) Also, the bitstream transcoding method according to the invention comprises the steps of: analyzing a data structure of a bitstream to be input to thereby detect whether a relevant macro block type is a “type accompanied by motion compensation and having a DCT coefficient”; transcoding all the DCT coefficients contained in the relevant macro block in the above-mentioned detection step to “0” and also transcoding the macro block type to a “type accompanied by motion compensation and having no DCT coefficient”; and outputting a bitstream having such a quantity of codes that is reduced in the above-mentioned transcode step.

In the above, an MBT of a “type accompanied by motion compensation and having a DCT coefficient” corresponds to “MC, Coded” according to the MPEG standard. An MBT of a “type accompanied by motion compensation and having no DCT coefficient” corresponds to “MC, Not Coded”. “MC, Coded” of an MBT is transcoded to “MC, Not Coded”.

(6) The bitstream transcoding method according to the invention comprises the steps of: analyzing a data structure of a bitstream to be input to thereby detect whether a relevant macro block type (MBT) is a “type accompanied by motion compensation, containing a block having a DCT coefficient, and being a variation point in a quantization step”; transcoding all the DCT coefficients in the relevant macro block in the above-mentioned detection step to “0” and also transcoding the macro block type to a “type accompanied by motion compensation and having no DCT coefficient”; and outputting a bitstream having such a quantity as reduced by the above-mentioned transcode step.

In the above, an MBT of a “type accompanied by motion compensation, containing a block having a DCT coefficient, and being a variation point in a quantization step” corresponds to “MC, Coded, Quant” according to the MPEG standard. “MC, Coded, Quant” of an MBT corresponds to “MC, Not Coded”.

(7) The bitstream transcoding method according to the invention comprises the steps of: analyzing a data structure of a bitstream to be input to thereby detect whether a relevant DCT block contains a DCT coefficient of a chrominance signal in a macro block; transcoding all the DCT coefficients in the DCT block of the relevant chrominance signal in the above-mentioned detection step to “0” and also changing a coded block pattern (CBP) correspondingly; and outputting a bitstream having such a quantity of codes that is reduced by the above-mentioned transcode step.

(8) The bitstream transcoding method according to the invention comprises the steps of: analyzing a data structure of a bitstream to be input to thereby detect whether a relevant DCT block contains a DCT coefficient of a chrominance signal in a macro block; leaving only one “non-zero” coefficient encountered first in scanning in a DCT block having therein a DCT coefficient of a luminance signal in a macro block corresponding to the above-mentioned detected DCT block of the chrominance signal to thereby transcode all the other DCT coefficients to “0”; transcoding all the DCT coefficient in the above-mentioned DCT block of the chrominance signal to “0” and also changing a coded block pattern correspondingly; and outputting a bitstream having such a quantity of codes that is reduced in the above-mentioned transcode step.

In this case, the DCT of the luminance signal and that of the chrominance signal are separated from each other in correspondence.

The above-mentioned bitstream transcoding methods of (2) through (8) are all capable of reducing the quantity of codes by use of processing in accordance with simple rules. Also, one coefficient is left as is, so that no SMB is generated, thus eliminating the need to update the address counter.

Also, preferred aspects of the bitstream transcoding method each comprise, in addition of those of at least one bitstream transcoding methods of (1) through (8) above, the steps of: replacing each picture of a bitstream to be input with a dummy picture; and outputting a bitstream having such a quantity of codes that is reduced by the above-mentioned replacing step, so that this plurality of aspects of the bitstream transcoding method is switched appropriately.

In this case, the dummy picture is rendered to such that has its quantity of codes being essentially 0 or extremely small, so that the step of replacement with the dummy picture enables generating a bitstream having a greatly reduced quantity of codes. If, only this method of replacing with the dummy picture is constantly used, however, the quality of contents such as images etc. may be deteriorated. To guard against this, switching is made appropriately between a state of selecting one of the transcoding methods of (1) through (8) and a state of selecting one of the methods of replacement with the dummy picture. Thus, it is possible to greatly reduce the quantity of codes contained in a bitstream while inhibiting the deterioration of the quality of the contents.

In the above, in a preferred aspect, each time a picture (I picture) given without using predictive coding is input, the above-mentioned plurality of methods transcoding of bitstreams is switched appropriately.

In another preferred aspect, each time a GOP header is input, the above-mentioned plurality of bitstream transcoding methods is switched appropriately.

In a further preferred aspect, each time a picture (I picture) given without using predictive coding is input and also each time a GOP header is input, the above-mentioned plurality of bitstream transcoding methods is switched appropriately.

Periodically or un-periodically, the plurality of bitstream transcoding methods of different aspects is switched in a cyclic or random manner. Thus, it is possible to prevent errors from being accumulated to thereby hold the quality of the contents high.

Also, in the bitstream transcoding method according to the invention, such a case is set at level 1 that performs, on a picture (B picture) employing bilateral prediction, one of the above-mentioned bitstream transcoding methods of (1) through (8) according to the invention; such a case is set at level 2 that performs the transcoding method for replacing a picture (B picture) employing bilateral prediction with a dummy picture; such a case is set at level 3 that performs any one of the above-mentioned transcoding methods (1) through (8) on a picture (P picture) employing forward prediction; such a case is set at level 4 that performs the transcoding method for replacing a picture (P picture) employing forward prediction with a dummy picture; and such a case is set at level 5 that performs a transcoding method for replacing a picture (I picture) not employing predictive coding with a dummy picture at a predetermined rate. The invention comprises also the steps of detecting an instruction for making switching among the above-mentioned levels 1 through 5 and making switching among these levels each time the above-mentioned switching instruction is given. The larger the level number, the lower bit rate is employed in transcoding of the pictures.

In this case, one of levels 1 through 5 is selected on the basis of using purposes and conditions to thereby enable reducing the quantity of bitstream codes in an optimal state of the using purposes and conditions. The invention has a considerably large number of selectable levels, thus providing wide versatility for a variety of purposes and conditions in use.

In the above, in a preferred aspect, the above-mentioned level switching is made each time a picture not employing predictive coding is input.

Also, in another preferred aspect, the above-mentioned switching is made each time a GOP header is input.

Also, in further preferred aspect, the above-mentioned level switching is made each time a picture not employing predictive coding is input and each time a GOP header is input.

Also, in a further another preferred aspect, the above-mentioned level switching is made at a predetermined time interval.

In those cases, by switching the plurality of bitstream transcoding methods of the different aspects in a cyclic or random manner to prevent errors from being accumulated, thus holding the quality of the contents high.

Although the above-mentioned preferred aspects have employed five levels, at least one of these levels may be left to thereby remove any desired one or more of the remaining levels.

The following will describe a bitstream transcoding apparatus.

The bitstream transcoding apparatus according to the invention comprises a code detecting means for analyzing a data structure of a bitstream which has been input and a DCT coefficients reducing means for transcoding DCT coefficients in a DCT block in the above-mentioned input bitstream to “0” leaving at least one “non-zero” DCT coefficient based on a data structure analyzing result by the above-mentioned code detecting means.

Also, the bitstream transcoding apparatus according to the invention comprises a code detecting means for analyzing a data structure of a bitstream which has been input, a DCT coefficients reducing means for transcoding DCT coefficients in a DCT block of the above-mentioned input bitstream to “0” leaving at least one “non-zero” DCT coefficient based on a data structure analyzing result by the above-mentioned code detecting means, and a macro-block type transcoding means for transcoding a macro block type of the above-mentioned input bitstream to such a macro block type that corresponds to a processing result by the above-mentioned DCT coefficients reducing means based on the data structure analyzing result by the above-mentioned code detecting means.

Also, the bitstream transcoding apparatus according to the invention comprises a code detecting means for analyzing a data structure of a bitstream which has been input, a DCT coefficients reducing means for transcoding DCT coefficients in a DCT block of the above-mentioned input bitstream to “0” leaving at least one “non-zero” DCT coefficient based on a data structure analyzing result by the above-mentioned code detecting means, and a coded block pattern transcoding means for transcoding a coded block pattern of the above-mentioned input bitstream to such a coded block pattern that corresponds to a processing result by the above-mentioned DCT coefficients reducing means based on the data structure analyzing result by the above-mentioned code detecting means.

By any one of the above-mentioned transcoding apparatuses, it is possible to implement in the apparatus the advantages of the corresponding one of the above-mentioned bitstream transcoding methods.

The following will describe a program storing medium employed.

The storing medium used in bitstream transcode according to the invention stores a program for executing a procedure for analyzing a data structure of a bitstream to be input and a procedure for transcoding DCT coefficients in a DCT block of above-mentioned bitstream to be input to “0” leaving at least one “non-zero” DCT coefficient based on a data structure analyzing result by the former procedure.

Also, the storing medium used in bitstream transcode according to the invention stores a program for executing a procedure for analyzing a data structure of a bitstream to be input, a procedure for transcoding DCT coefficients in a DCT block of the above-mentioned bitstream to be input leaving at least one “non-zero” DCT coefficient based on a data structure analyzing result by the first procedure, and a procedure for transcoding a macro block type of the above-mentioned bitstream to be input to such a macro block type that corresponds to a result of the above-mentioned DCT coefficients transcode based on the above-mentioned data structure analyzing result.

Also, the storing medium used in bitstream transcode according to the invention stores a program for executing a procedure for analyzing a data structure of a bitstream to be input, a procedure for transcoding DCT coefficients in a DCT block of above-mentioned bitstream to be input to “0” leaving at least one “non-zero” DCT coefficient based on a data structure analyzing result by the former procedure, and a procedure for transcoding a coded block pattern of the above-mentioned bitstream to be input to such a coded block pattern that corresponds to a result of the above-mentioned DCT coefficients transcode based on the above-mentioned data structure analyzing result.

By any one of the above-mentioned storing media, it is possible to implement in the storing medium the advantages of the corresponding one of the above-mentioned bitstream transcoding methods.

### BRIEF DESCRIPTION OF THE DRAWINGS

These and other objects, advantages, features, and uses of the invention will become more apparent from the following description of preferred embodiments of the invention with reference to the accompanying drawings wherein:

FIG. 1 is a block diagram for showing a configuration of important elements of a bitstream transcoding apparatus according to a first embodiment of the invention;

FIG. 2 is an illustration for explaining signal processing according to the first embodiment of the invention;

FIG. 3 is an illustration for explaining signal processing according to a second preferred embodiment of the invention;

FIG. 4 is an illustration for explaining signal processing according to a third preferred embodiment of the invention;

FIG. 5 is an illustration for explaining signal processing according to a fourth preferred embodiment of the invention;

FIG. 6 is a block diagram for showing a configuration of important elements of a bitstream transcoding apparatus according to a fifth preferred embodiment of the invention;

FIG. 7 is a block diagram for showing a configuration of important elements of a bitstream transcoding apparatus according to a sixth preferred embodiment of the invention;

FIG. 8 is a block diagram for showing a configuration of important elements of a bitstream transcoding apparatus according to a seventh preferred embodiment of the invention;

FIG. 9 is an illustration for explaining five transcoding methods which a bitstream transcoding apparatus according to an eighth preferred embodiment of the invention includes;

FIG. 10 is an illustration for explaining a structure of layers in a bitstream according to the MPEG2 standard;

FIG. 11 is an illustration for explaining kinds of MBTs in a P picture according to the MPEG standard;

FIG. 12 is an illustration for explaining DCT blocks contained in an MB according to the MPEG standard; and

FIG. 13 is an illustration for explaining a scanning order in DCT blocks according to the MPEG standard.

In all these figures, like components are indicated by the same reference numerals.

### DETAILED DESCRIPTION OF THE PREFERRED EMBODIMENTS

The following will describe preferred embodiments of a method and an apparatus for transcoding a bitstream according to the invention with reference to the drawings.

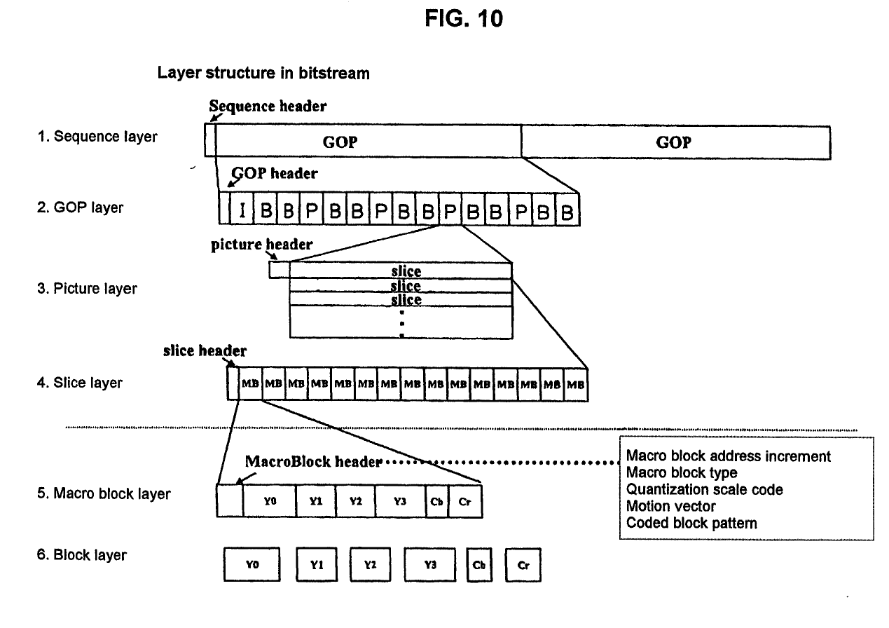

Bitstreams to be dealt with in those embodiments are described with reference to FIGS. 10-13. As one example, bitstreams according to the MPEG2 (ISO/IEC13818-2) are described below.

As shown in FIG. 10, a bitstream according to the MPEG2 standard has therein six layers. They are a sequence layer, a GOP layer, a picture layer, a slice layer, an MB layer, and a block layer. The header of the four layers of the sequence, GOP, picture, and slice layers has a flag for synchronization. The bits are to be reduced in the MB and block layers.

An MB header, which is a header of an MB layer, contains as main information a macro block address increment (MBAI), a macro block type (MBT), a quantization scale code (QSC), a motion vector (MV), and a coded block pattern (CBP).

MBAI: indicates the number of MBs which are present between a skip macro block (SMB) having no quantity of codes and a preceding MB which is not an SMB.

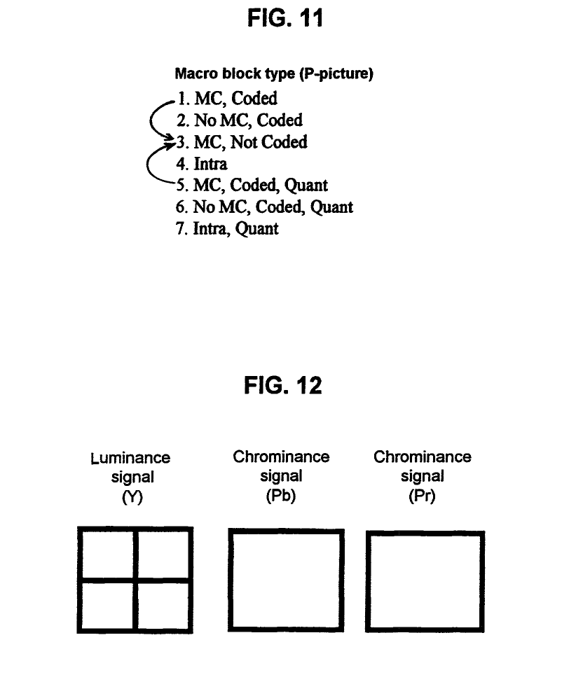

MBT: indicates a type of coding in video compression according to the MPEG2 standard. One example of an MBT of a P picture employing forward prediction is shown in FIG. 11.

QSC: indicates the magnitude of a quantization step when an MB is quantized.

MV: indicates the magnitude of a motion which is present only in an MB accompanied by motion compensation.

CBP: indicates that there is a block that none of the coefficients in DCT blocks in an MB is “0”.

As shown in FIG. 11, there are seven kinds of codes in a P picture MBT.

“MC” indicates performing of motion compensation employing a motion vector of a not “0” motion.

“Coded” indicates that there is a block that none the coefficients in DCT blocks in an MB is “0” and also that there is CBP information in that MB.

“No MC” indicates that a motion vector of a “0” motion.

“Not Coded” indicates that all the coefficients in all DCT blocks in an MB are “0”, that is, there is no DCT coefficient present.

“Intra” indicates that no motion compensation is performed, thus using an input signal as is.

“Quant” indicates that a quantization step changes in an MB and also that there is quantization scale code information present in that MB.

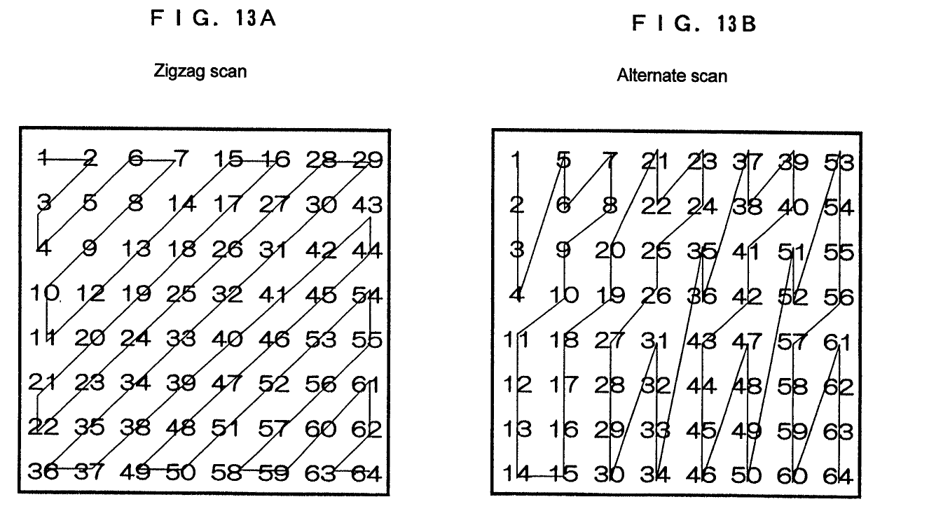

As shown in FIG. 12, in a main profile according to the MPEG2 standard, an MB contains four DCT blocks for each luminance signal (Y) and one block for each chrominance signal (Pr, Pb). Those are sampled at a rate of 4:2:0.

The scanning of DCT coefficients in a DCT block may be performed in a zigzag scan order shown in FIG. 13A or an alternate scan order shown in FIG. 13B. The coefficient at position 1 is a DC component and that at any other positions is an AC component. The later in the scanning order, the higher will be the frequency both horizontally and vertically.

First Embodiment

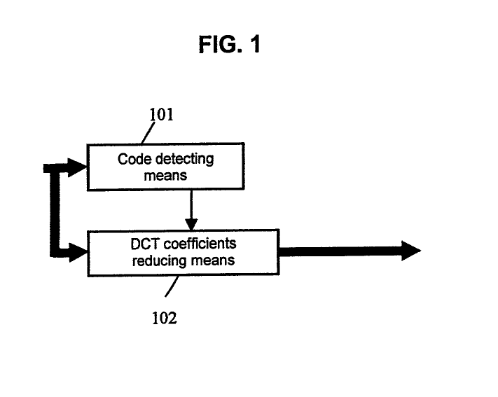

The following will describe a bitstream transcoding apparatus according to the first embodiment with reference to FIG. 1.

A code detecting means 101 analyzes an MPEG2 standard image data layer structure when a relevant bitstream is input to thereby detect whether there is present a DCT block which contains a code corresponding to a DCT coefficient and, if there is one, outputs a predetermined instruction signal to a DCT coefficients reducing means 102.

The DCT coefficients reducing means 102, when having received the instruction signal, performs required DCT coefficients reducing processing on the incoming bitstream. This processing specifically transcodes all DCT coefficients to “0” but only one “non-zero” coefficient (run level information appearing first) encountered first in scanning in the DCT block, leaving an EOB code (EOB: End Of Block). Further, the following processing is performed as for a position at which a flag appears for synchronization of the sequence, GOP, picture, and slice layers. Suppose that the bitstream is delimited in one-byte units starting from its top. For each slice, at the beginning of the header (at the end of the code), “0” is inserted or deleted so that a flag of that slice may appear at the top of the byte.

The DCT coefficients reducing means 102 performs the following processing on the bitstream to then output it with a reduced quantity of bits.

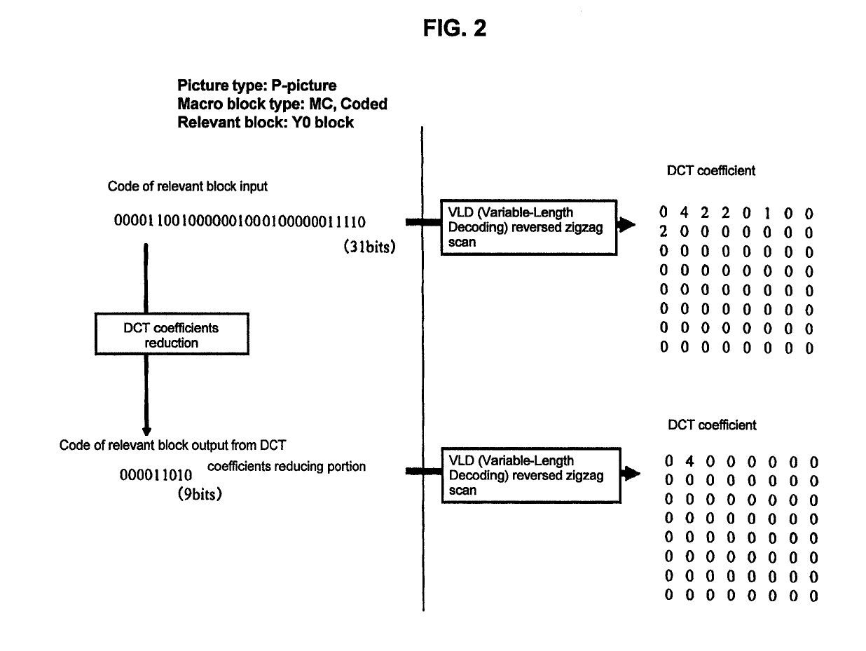

One example of the signal processing is described with reference to FIG. 2 as follows. The picture type of a block to undergo this processing is a P picture employing forward prediction. The MBT is “MC, Coded”. Suppose that the code of a DCT block of a luminance signal to be input consists of the following 31 bits:

0000110010000001000100000011110

Then, the DCT coefficients reducing means 102 reduces this bit string consisting of 31 bits to the following nine bits:

000011010

The code detecting means 101 decides by analysis that by decoding this input bit string of 31 bits in a variable-length format and scanning it in a reversed zigzag order, such a DCT coefficient [04200220000 . . . ] is generated as shown at the right top corner in FIG. 2. Since the result of this analysis shows that there is a DCT block that contains a DCT coefficient, the code detecting means 101 outputs to the DCT coefficients reducing means 102 such a predetermined instruction signal that implies that the “non-zero” coefficient that appears last is The DCT coefficients reducing means 102, when having received the instruction signal, leaves unchanged only [0000110] that corresponds to the first appearing “non-zero” coefficient of “4” except all the DC components encountered sequentially in scanning and then generates a nine-bit code to which an EOB [10] is added and outputs it.

Now, a correspondence is considered between the code of the input bitstream and the DCT coefficient encountered in reversed zigzag scanning when this code is decoded in a variable-length format.

The above-mentioned input code is divided as follows:

0000110 0100 0000100 0100 0000111 10

The bits of a DCT code which corresponds to a variable-length decoded version of this divided code are arranged except the DC components in the zigzag scanning order as follows:

4 2 0 0 2 2 0 0 0 0 0 0 0 0 1 0 . . .

Thus, the first “4” has run level information of (0, 4), a variable-length coded version corresponding to which will be the following code according to the MPEG standard:

0000110

Thus, the following “2” has run level information of (0, 2), a variable-length coded version corresponding to which will be the following code:

0100

The following [002] has run level information of (2, 2), a variable-length coded version corresponding to which will be the following code:

0000100

The following “2” has run level information of (0, 2), a variable-length coded version corresponding to which will be the following code:

0100

The following [000000001] has run level information of (8, 1), a variable-length coded version corresponding to which will be the following code:

0000111

Then, the following consists of only “0” and so an EOB appears, which is:

10

[0000110], which corresponds to “4” appearing first in scanning, is given an addition of [10] of the EOB, resulting in the following nine bits:

000011010

This bit string is output from the DCT coefficients reducing means 102.

In an MPEG2 bitstream, for each slice layer, the code needs to be divided by a byte (eight bits) without a remainder. If the code cannot be done so, “0” is inserted or deleted at the end of the code in a slice layer so as to divide it without a remainder. The number of bits of the above-mentioned 31-bit string is 31 and so divided with a remainder of 7, while the number of bits of a nine-bit string is nine and so divided with a remainder of 1, which is different from the former remainder.

The code detecting means 101 instructs also this insertion of deletion of “0” to the DCT coefficients reducing means 102. The DCT coefficients reducing means 102 follows this instruction to thereby inset or delete “0” as many as a required number.

Thus, such processing is performed that follows a simple rule of transcoding all DCT coefficients to “0” except one “non-zero” coefficient encountered first in scanning in a DCT block. In contrast to the prior art, it is not necessary to calculate a target bit rate for each picture or for each block or MB. Also, it is not necessary to compare a generated bit rate and the target bit rate to each other to thereby change the processing based on the comparison result. Further, such an SMB is not generated that its DCT coefficients are all transcoded to “0”. Therefore, there is not need to update the address counter, thus enabling simplifying the processing.

Also, since the invention employs a method of performing the processing according to such a simple rule, even with a low-throughput processing unit employed, it is possible to implement on a real-time basis the bitstream transcode processing accompanied by reduction of the quantity of codes. No high-grade processing unit needs to be mounted, thus enabling reducing the costs in the provision such as an image distribution system.

Second Embodiment

The bitstream transcoding apparatus according to a second embodiment has the same configuration as that of FIG. 1.

The code detecting means 101 analyzes an image data layer structure of an incoming bitstream. It decides whether the picture type is a P picture employing forward prediction or a B picture employing bilateral prediction or whether the MBT is an Inter MB employing motion compensation and, it decides so, outputs a predetermined instruction signal to the DCT coefficients reducing means 102.

The DCT coefficients reducing means 102, when having received the instruction signal, performs required DCT coefficients reducing processing on the incoming bitstream. The processing specifically extracts codes that corresponds to DCT coefficients in the MB and transcodes all AC coefficients other than the DC coefficients in the DCT block to “0”. The processing, however, leaves the EOB code un-transcoded. If the DC coefficient is “0”, a predetermined AC coefficient is added. Also, for synchronization of the sequence, GOP, picture, and slice layers, at the beginning of the header, “0” is inserted or deleted. Thus, the DCT coefficients reducing means 102 performs the above-mentioned processing on the incoming bitstream to thereby reduce the quantity of the codes and then output it.

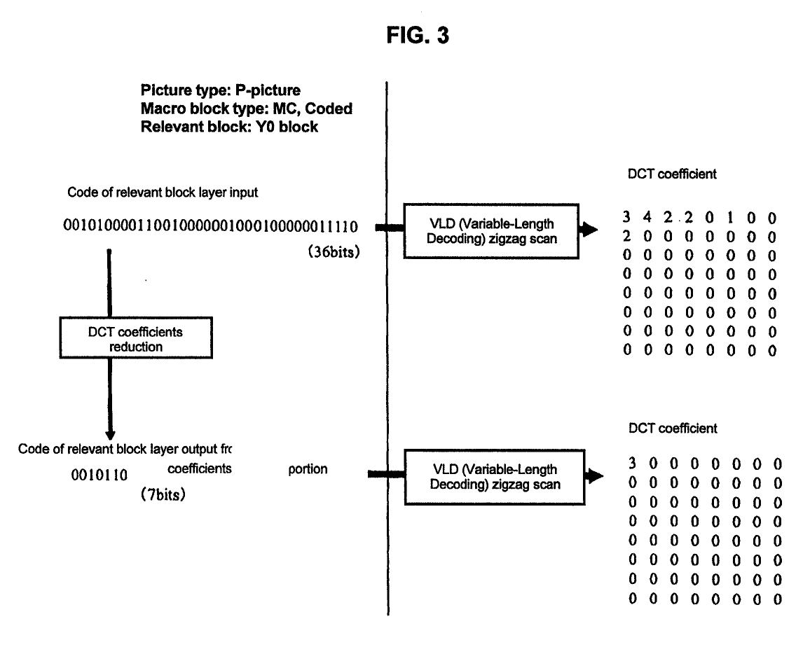

One example of the signal processing is described with reference to FIG. 3 as follows. It is here supposed that a block to be processed has a picture type of a P picture and an MBT is (Coded). The code of a DCT block of the luminance signal is supposed to consist of the following 36 bits:

001010000110010000001000100000011110

Those 36 bits consist of 31 bits of the case of the first embodiment and additional starting five bits of [00101] (which corresponds to “3” in the decimal notational system; DC coefficient). This bit string is reduced by the DCT coefficients reducing means 102 to the following seven bits:

0010110

That is, the code detecting means 101 decides by analysis that the input 36-bit bit string can be variable-length decoded and scanned in a reversed zigzag format to thus generate a DCT coefficient [3420022000 . . . ] shown at the right top corner in FIG. 3. As a result of this analysis, the code detecting means 101 outputs to the DCT coefficients reducing means 102 a predetermined instruction signal implying that the DCT coefficient is “3”.

When having received the instruction signal, the DCT coefficients reducing means 102 leaves as unchanged only [00101] which corresponds to “3” as the value of the DCT coefficient and also generates a 7-bit code to which an EOB [10] is added and outputs it.

The DC coefficient “3” has run level information of (0, 3) and has the following corresponding variable-length coding code:

00101

To this the EOB [10] is added to result in the following seven bits:

0010110

This bit string is output from the DCT coefficients reducing means 102.

Also, the remainder given in division by eight (8) is different between the cases of 36 bits and seven bits. Accordingly, “0” is inserted or deleted at the end of the slice layer. An instruction to this effect is also given by the code detecting means 101 to the DCT coefficients reducing means 102.

As described above, in the case where the picture type is a P or B picture, processing according to such a simple rule that transcodes all AC coefficients other than the DC coefficients to “0” is performed on an Inter MB of an MBT employing motion compensation.

Third Embodiment

The bitstream transcoding apparatus according to a third embodiment has the same configuration as that of FIG. 1.

The code detecting means 101 analyzes an image data layer structure of a bitstream. It decides whether the picture type is a P or B picture and whether a relevant block is an Intra MB of an MBT employing motion compensation and, if it decides so, outputs a predetermined instruction signal to the DCT coefficients reducing means 102.

The DC coefficients reducing means 102, when having received the instruction signal, performs required DCT coefficients reducing processing on the incoming bitstream. The processing specifically transcodes all DC coefficients other than the DCT coefficients in the DCT block to “0”. The EOB code, however, is left as it is. Further, for synchronization of the layers, “0” is inserted or deleted at the beginning of the header of the slice layer. Thus, the DCT coefficients reducing means 102 performs the above-mentioned processing on the incoming bitstream to reduce the quantity of the codes and then outputs it.

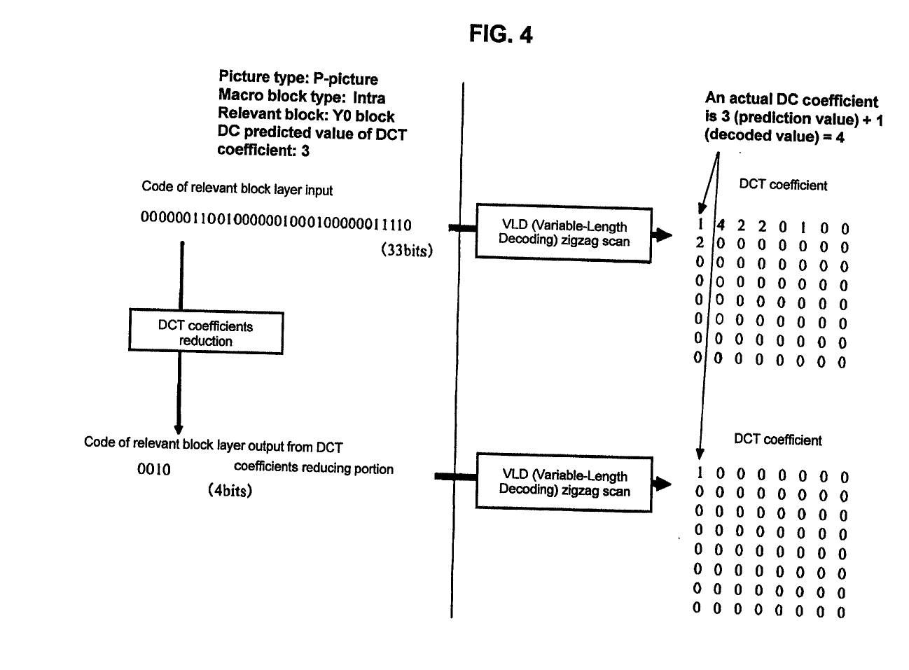

One example of the signal processing is described with reference to FIG. 4. Suppose that when a block to be processed has a picture type of a P picture and has an MBT of intra coding and also has a prediction value “3” of the DPCM of the DC coefficient in the DCT block of the luminance signal, the code of the DCT block of the incoming luminance signal consists of the following 33 bits:

000000110010000001000100000011110

Those 33 bits consist of the above-mentioned 31 bits and additional starting two bits [00] (which corresponds to the DC coefficient “13” in the case of intra coding). This 33-bit bit string is reduced by the DCT coefficients reducing means 102 to the following four bits:

0010

That is, the code detecting means 101 decides by analysis that the incoming 33-bit bit string can be variable-length decoded and scanned in a zigzag format to thereby generate a DCT coefficient [1420022000 . . . ] shown at the right top corner in FIG. 4. As a result of this analysis, the code detecting means 101 outputs to the DCT coefficients reducing means 102 a predetermined instruction signal implying that the DC coefficient is “1”. The actual DC coefficient, however, is “4” obtained by adding the above-mentioned value “1” to the DPCM prediction value of “3”.

The DCT coefficients reducing means 102, when having received the instruction signal, leaves unchanged only [00] which corresponding to the DC coefficient “1” and generates a 4-bit code to which the EOB [10] is added and outputs it.

The DC coefficient employed in intra coding is particularly prescribed, so that the variable-length coding code is:

00

To this bit string, an EOB [10] is added to result in the following four bits:

0010

This bit string is output from the DCT coefficients reducing means 102.

Also, the remainder in division by eight is different between the cases of 33 bits and four bits, so that “0” is inserted or deleted at the end of the slice layer.

Thus, in the case where the picture type is a P or B picture, processing according to such a simple rule that transcodes all AC coefficients other than the DC coefficients to “0” is performed on an Intra MB of an MBT not employing motion compensation.

Fourth Embodiment

The bitstream transcoding apparatus according to a fourth embodiment has the same configuration as that of FIG. 1.

The code detecting means 101 analyzes an image data layer structure of a bitstream. It decides by analysis whether there is such a DCT block present that contains a code corresponding to a DCT coefficient and, if it decides so, outputs a predetermined instruction signal to the DCT coefficients reducing means 102.

The DCT coefficients reducing means 102, when having received the instruction signal, leaves as they are only the first through N'th (N is an integer of 1 through 64) coefficients encountered in scanning within the DCT block and transcodes all the other DCT coefficients to “0”. The EOB, however, is left as it is. If, in this case, the first through N'th DCT coefficients are all “0”, a predetermined AC coefficient is added. Further, for synchronization of the layers, “0” is inserted or deleted at the beginning of the header of the slice layer. Thus, the DCT coefficients reducing means 102 performs the above-mentioned processing on an incoming bitstream to thereby reduce its quantity of the codes and then outputs it.

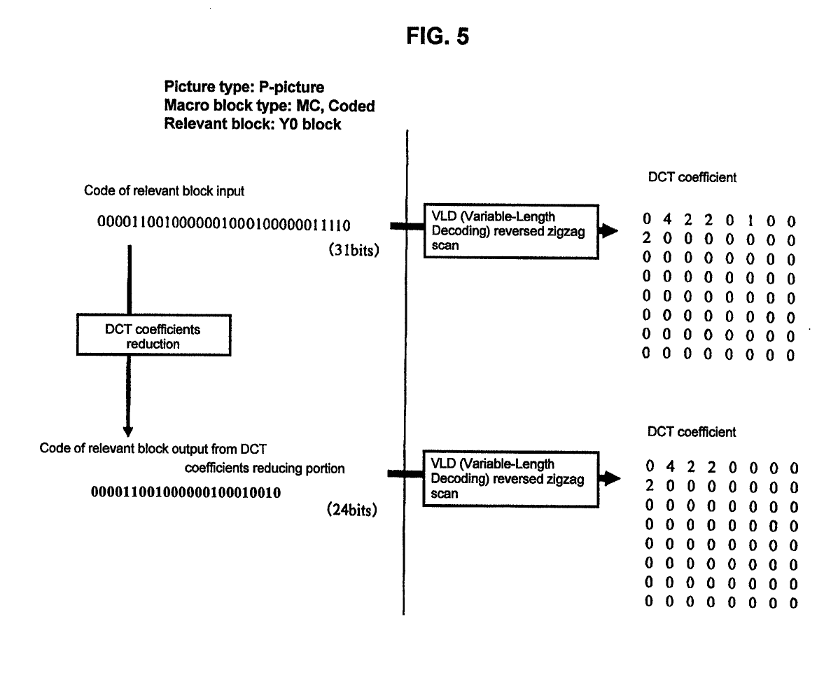

One example of the signal processing is described with reference to FIG. 5 as follows. It is supposed that a block to be processed has a picture type of a P picture and an MBT of (Coded). Like in the case of FIG. 2, the code of the DCT block of the incoming luminance signal is supposed to consist of the following 31 bits:

0000110010000001000100000011110

Also, it is supposed that N=10 (in the decimal notational system).

The DCT coefficients reducing means 102 reduces this 31-bit bit string to the following 24 bits:

000011001000000100010010

That is, the code detecting means 101 decides by analysis that the incoming 31-bit bit string can be variable-length decoded and scanned in a zigzag format to thereby generate a DCT coefficient [0420022000 . . . ] shown at the right top corner of FIG. 5. As a result of this analysis, it outputs a predetermined instruction signal to the DCT coefficients reducing means 102.

The DCT coefficients reducing means 102, when having received the instruction signal, leaves as they are only the first through N'th (N=10) coefficients [0420022000] encountered in scanning (to delete the following 000001) and generates a 24-bit code to which an EOB [10] is added and outputs it.

Also, the remainder in division by eight (8) is different between the cases of 31 bits and 24 bits, so that “0” is inserted or deleted at the end of the slice layer.

Thus, such processing is performed that follows a simple rule of leaving as they are only the first through N'th coefficients encountered in scanning of a DCT block and transcoding all the (N+1)'th and subsequent DCT coefficients to “0”.

Fifth Embodiment

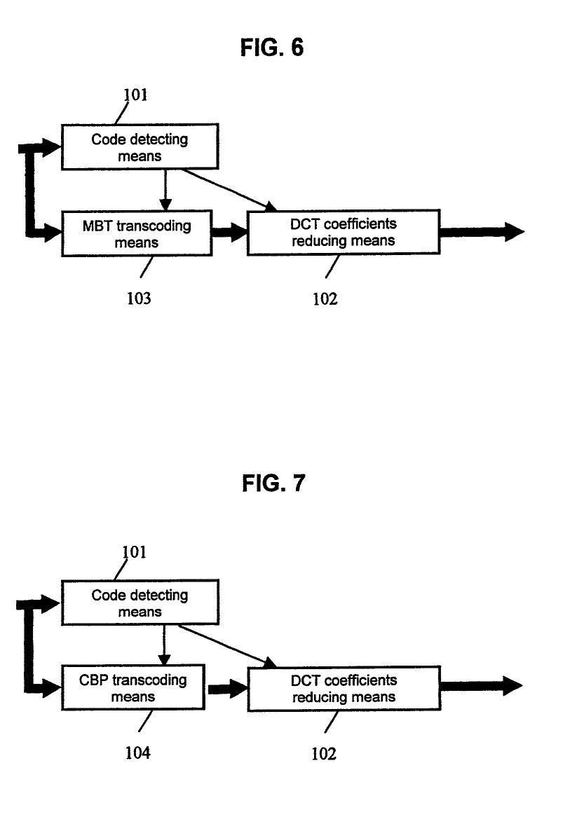

The following will describe a bitstream transcoding apparatus according to a fifth embodiment with reference to FIG. 6. A reference numeral 103 indicates an MBT transcoding means.

The code detecting means 101 analyzes an image data layer structure of a bitstream. It decides whether the MBT is a type 1 of (MC, Coded) or a type 5 of (MC, Coded, Quant) shown in FIG. 11. If it decides so, it outputs a predetermined instruction signal to the MBT transcoding means 103 and the DCT coefficients reducing means 102.

The MBT transcoding means 103 follows the instruction signal it has received to thereby transcode an MBT indicated in the bitstream and then output it. That is, as shown in FIG. 11, if the MBT is (MC, Coded) or (MC, Coded, Quant), that MBT is transcoded to (MC, Not, Coded).

The DCT coefficients reducing means 102 performs desired DCT coefficients reducing processing on the incoming bitstream. When the MBT is (MC, Coded), the processing transcodes all the DCT coefficients to “0”. If it is (MC, Not Coded), that processing transcodes all the quantization scale code and the DCT coefficients to “0”. Further, for synchronization of the layers, “0” is inserted or deleted at the beginning of the header of the slice layer. Thus, the DCT coefficients reducing means 102 performs the above-mentioned processing on the incoming bitstream to thereby reduce its quantity of the codes and then outputs it.

As described above, if the MBT is (MC, Coded), it is transcoded to (MC, Not Coded) and also the DCT coefficients are all transcoded to “0” by the DCT coefficients reducing means 102. If the MBT is (MC, Coded, Quant), on the other hand, it is transcoded to (MC, Not Coded) and also all the quantization scale code and the DCT coefficients are transcoded to “0”. Thus, although the processing changes the MBT, it yet has to follow only a simple rule, being able to be performed easily as compared to the prior art case.

Sixth Embodiment

The following will describe the bitstream transcoding apparatus according to a sixth embodiment with reference to FIG. 7. A reference numeral 104 indicates a CBP transcoding means. A CBP indicates of which pattern is each of the six DCT blocks in an MB.

The code detecting means 101 analyzes an image data layer structure of an incoming bitstream. When a DCT block of a chrominance signal is detected, it outputs a predetermined instruction signal to the CBP transcoding means 104 and the DCT coefficients reducing means 102.

The CBP transcoding means 104 follows the incoming instruction signal to thereby transcode the CBP for the DCT block of the chrominance signal to such a CBP that has no DCT coefficient.

The DCT coefficients reducing means 102, when having received the instruction signal, transcodes all the DCT coefficients in the DCT block of the chrominance signal to “0” for the incoming bitstream. Further, for synchronization of the layers, “0” is inserted or deleted at the beginning of the header of the slice layer. Thus, the DCT coefficients reducing means 102 performs the above-mentioned processing on the incoming bitstream to thereby reduce its quantity of codes and then outputs it.

Note here that the code detecting means 101 has a function for leaving only one “non-zero” coefficient encountered first in scanning in the DCT block to thereby transcode all the other DCT coefficients to “0” and leaves the EOB code unchanged.

Thus, for a DCT block of the chrominance signal, its CBP is transcoded to such a CBP that has no DCT coefficient. Then, all the DCT coefficients in the DCT block of that chrominance signal are transcoded to “0”. Although the processing changes the CBP, it yet has to follow only a simple rule, being able to be easily performed as compared to the prior art case.

Seventh Embodiment

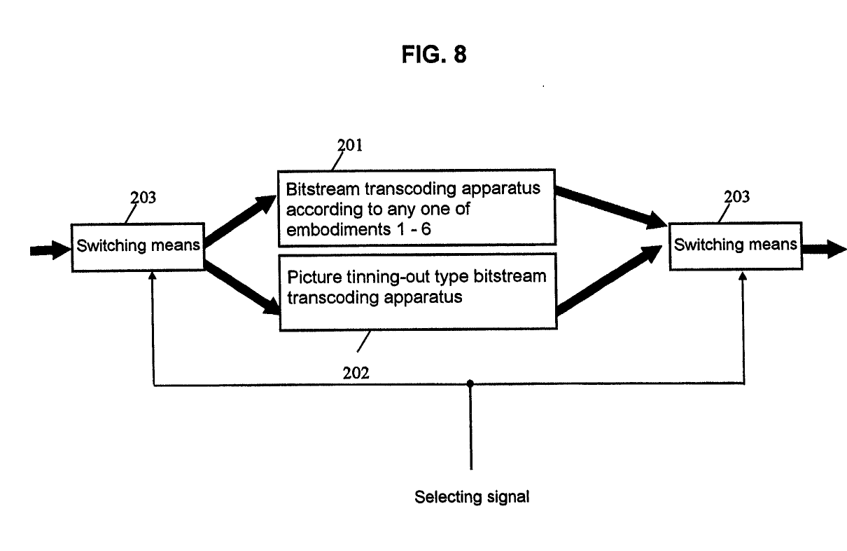

The following will describe the bitstream transcoding apparatus according to a seventh embodiment with reference to FIG. 8. A reference numeral 201 indicates a bitstream transcoding apparatus (new transcoding apparatus), a reference numeral 202 indicates a picture thinning-out type bitstream transcoding apparatus, and a reference numeral 203 indicates a switching means according to any one of the first through sixth embodiments.

The thinning-out type bitstream transcoding apparatus 202 replaces all B pictures and/or P pictures with a dummy picture and outputs them. The dummy picture refers to such a picture that has no inter-frame difference information or inter-field difference information but has only header information indicating a type of the picture. Alternately, the dummy picture may be copied from a picture having any one of the picture types already processed.

The switching means 203, when having received a selecting signal from the outside, makes switching between processing by the new transcoding apparatus 201 and processing by thinning-out type transcoding apparatus 202.

The new transcoding apparatus 201 may be of three types or more. The selecting signal from the outside may be input at a predetermined time interval or may be input each time I picture not employing predictive coding is received or for each GOP.

The plurality of bitstream transcoding methods can thus be selected, thereby reducing the rate of bitstreams as well as adjusting an output bit rate.

Eighth Embodiment

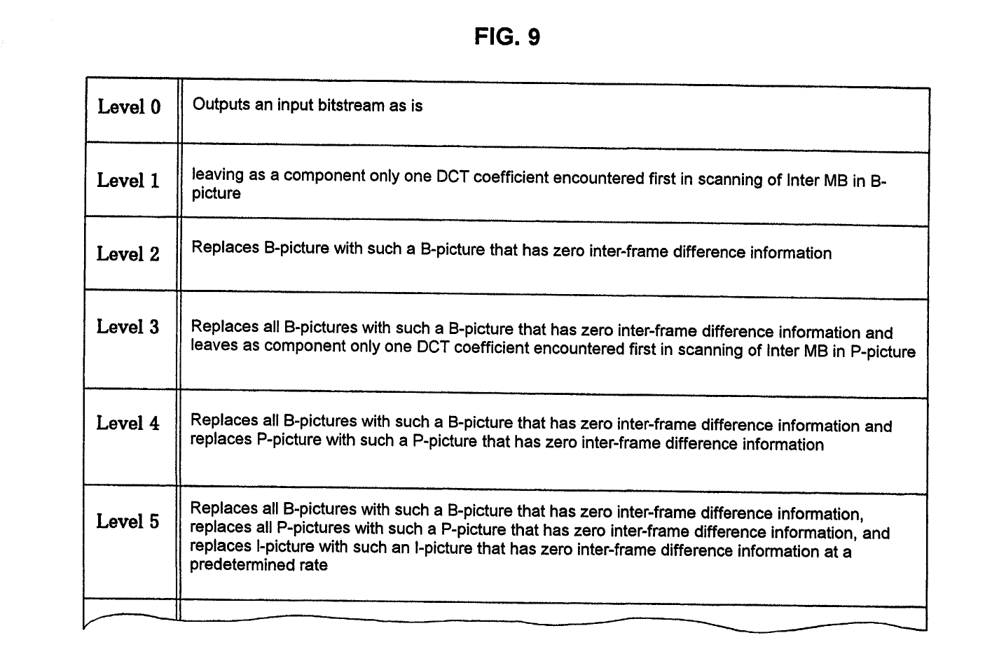

The following will describe the bitstream transcoding apparatus according to an eighth embodiment with reference to FIG. 9.

At level 0, a bitstream which is input is output as it is.

At level 1, only one “non-zero” coefficient encountered first in scanning in a DCT block of an Inter MB in a B picture is left as it is to transcode all the other DCT coefficients to “0”, leaving the EOB code unchanged.

At level 2, a B picture is replaced with a dummy B picture.

At level 3, all the B pictures are replaced with a dummy B picture and, only one “non-zero” coefficient encountered first in scanning in a DCT block of an Inter MB in a P picture is left as it is to transcode all the other DCT coefficients to “0”, leaving the EOB code unchanged.

At level 4, all the B pictures are replaced with a dummy B picture and, a P picture is replaced with a dummy P picture that has inter-frame difference information of “0”.

At level 5, all the B pictures are replaced with a dummy B picture and all the P pictures are replaced with a dummy P picture and also an I picture is replaced with a dummy P picture at a predetermined rate.

The above-mentioned five levels have a larger reduction in bit rate with an increasing level value thereof.

This bitstream transcoding apparatus, when having received target output bit rate information from the outside, selects an optimal one of the five levels in processing, thus enable effectively controlling code quantity reduction processing.

Note here that there is no need to have all of those five levels.

At level 1, there is no need to thin out DCT coefficients for all of the B pictures and the number of the B pictures in which the DCT coefficients are to be thinned out may be set as a sub-level. Similarly, at level 3, there is no need to thin out DCT coefficients for all the P pictures and the number of the P pictures in which DCT coefficients are to be thinned out may be set as a sub-level.

At level 2, there is no need to replace all the B pictures with a dummy picture and the number of the B pictures to be replaced with the dummy picture may be set as a sub-level. Similarly, at level 4, there is no need to replace all the P pictures with a dummy picture and the number of the P pictures to be replaced with the dummy picture may be set as a sub-level.

At level 5, a sub-level may be set so that the predetermined rate for the I pictures to be replaced with a dummy P picture can be changed.

The bit rate for B pictures at level 2 may be reduced by any one or any combination of the methods according to the first through sixth embodiments. The bit rate for P pictures at level 4 may be reduced by any one or any combination of the methods according to the first through sixth embodiments.

The level may also be switched at the predetermined time interval or may be switched each time an I picture not employing predictive coding is input or for each GOP.

Thus, by combining the plurality of the bitstream transcoding methods corresponding to the levels and adjusting an output bit rate corresponding to the levels, the bitstream rate can be more dynamically reduced according to a change in using purposes and conditions.

If the input bit rate and the image signal format are fixed, the output bit rate at each level can be fixed at a higher accuracy. Accordingly, a method according to the present embodiment eliminates the need of controlling the quantity of codes for each block or MB, thus facilitating the processing. Also, the larger the number of levels, the higher the accuracy will be for controlling the quantity of codes. Also, the shorter the level switching interval, the higher the accuracy will be for controlling the quantity of codes. Also, as for the output bit rate, by changing the level according to a margin, an overflow can be prevented from occurring.

Although the above-mentioned embodiments have been described with reference to the MPEG2 standard for simplicity, the MPEG1 or MPEG4 standard may be exemplified. Also, the functions of the means employed in the embodiments can be partially or totally realized by programs running in a personal computer. Also, such programs can be installed in such a device as DPS. Also, those programs can be stored in such a storage medium as a CD-ROM or a floppy disk that can be read out by a personal computer or be electrically distributed over the internet, etc.

Thus, the embodiments of the invention enable reducing the quantity of the codes of coding data in a bitstream of an image signal, etc. without decoding that data into the image signal. Further, in reducing that quantity of the codes, the present embodiments do not employ processing according to complicated rules in contract to the prior art embodiment. By the present embodiments, only one coefficient encountered first in scanning is left as it is. Only the DC coefficient is left. The MBT is changed and all the DCT coefficients are transcoded to “0”. The CBP is changed and all the DCT coefficients are transcoded to “0”. In any case, the processing follows only simple rules. Also, in principle, only one coefficient is left or the MBT or the CBP is changed to thereby eliminate the need of updating the address counter caused by generation of an SMB, thus enabling simplifying the processing. Even with a low-throughput processing unit, it is possible to realize on a real-time basis the bitstream transcode processing accompanied by reduction of the quantity of codes. By the present embodiments, there is no need to mount a high-grade processing unit, thus enabling reducing the costs in such a provision as an image distribution system.

While there has been described what is at present considered to be preferred embodiments of the invention, it will be understood that various modifications may be made therein, and it is intended to cover in the appended claims all such modifications as fall within the true spirit and scope of the invention.

What is claimed is:

1. A bitstream transcoding method comprising the steps of:
analyzing a data structure of a bitstream to be input to thereby detect whether a relevant DCT block contains a DCT coefficient in a macro block;
leaving as is only one “non-zero” coefficient encountered first in scanning in said DCT block detected to contain said DCT coefficient and transcoding all the other DCT coefficients to “0”; and
outputting said bitstream having a code quantity thereof reduced by said transcoding step.

2. A bitstream transcoding method comprising the steps of:
analyzing a data structure of a bitstream to be input to thereby detect whether a relevant DCT block contains a DCT coefficient in an inter-macro block accompanied by predictive coding;
leaving as is only a DC coefficient in said DCT block detected to contain said DCT coefficient in said inter-macro block and transcoding all the other AC coefficients to “0”; and
outputting said bitstream having a code quantity thereof reduced by said transcoding step.

3. The bitstream transcoding method according to claim 2, wherein if said DC coefficient is “0”, a predetermined AC coefficient is assigned as said coefficient to be left as is.

4. A bitstream transcoding method comprising the steps of:
analyzing a data structure of a bitstream to be input to thereby detect whether a relevant DCT block contains a DCT coefficient in an intra-macro block not accompanied by predictive coding;
leaving as is only a DC coefficient in said DCT block detected to contain said DCT coefficient in said intra-macro block and transcoding all the other AC coefficients to “0”; and
outputting said bitstream having a code quality thereof reduced by said transcoding step.

5. A bitstream transcoding method comprising the steps of:
analyzing a data structure of a bitstream to be input to thereby detect whether a relevant DCT block contains a DCT coefficient in a macro block;
leaving as are only the first through N'th coefficients (N: natural number) in said DCT block detected to contain said DCT coefficient and transcoding all the other DCT coefficients to “0”; and
outputting said bitstream having a code quantity thereof reduced by said transcoding step.

6. The bitstream transcoding method according to claim 5, wherein when said first through N'th coefficients encountered in said scanning are all “0”, a predetermined AC coefficient is assigned as said coefficient to be left as is.

7. A bitstream transcoding method comprising the steps of:
analyzing a data structure of a bitstream to be input to thereby detect whether a macro block type indicates “performing of motion compensation and containing of a block having a DCT coefficient”;
transcoding all DCT coefficients in a macro block concerned in said detection to “0” and transcoding said macro block type to such a type that indicates “performing of motion compensation and having no DCT coefficient”; and
outputting said bitstream having a code quantity thereof reduced by said transcoding step.

8. A bitstream transcoding method comprising the steps of:
analyzing a data structure of a bitstream to be input to thereby detect whether a macro block type indicates “performing of motion compensation, containing of a block having a DCT coefficient, and being a variation point in a quantization step”;
transcoding all DCT coefficients in a macro block concerned in said detection to “0” and transcoding said macro block type to such a type that indicates “performing of motion compensation and having no DCT coefficient”; and
outputting said bitstream having a code quantity thereof reduced by said transcoding step.

9. A bitstream transcoding method comprising the steps of:
analyzing a data structure of a bitstream to be input to thereby detect whether a relevant DCT block contains a DCT coefficient of a chrominance signal in a macro block;
transcoding all DCT coefficients in said DCT block of said chrominance signal concerned in said detection to “0” and changing a coded block pattern correspondingly; and
outputting said bitstream having a code quantity thereof reduced by said transcoding step.

10. A bitstream transcoding method comprising the steps of:
analyzing a data structure of a bitstream to be input to thereby detect whether a relevant DCT block contains a DCT coefficient of a chrominance signal in a macro block;
leaving as is only one “non-zero” coefficient encountered first in scanning in said DCT block containing said DCT coefficient of said luminance signal in a macro block corresponding to said DCT block of said chrominance signal concerned in said detection and transcoding all the other DCT coefficients to “0”;
transcoding all DCT coefficients in said DCT block of said chrominance signal concerned in said detection to “0” and changing a coded block pattern correspondingly; and
outputting said bitstream having a code quantity thereof reduced by said transcoding step.

11. A bitstream transcoding method comprising the steps of:
analyzing a data structure of a bitstream to be input to thereby detect whether a relevant DCT block contains a DCT coefficient in a macro block;
leaving as is only one “non-zero” coefficient encountered first in scanning in said DCT block detected to contain said DCT coefficient and transcoding all the other DCT coefficients to “0”;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

12. A bitstream transcoding method comprising the steps of:
analyzing a data structure of a bitstream to be input to thereby detect whether a relevant DCT block contains a DCT coefficient in an inter-macro block accompanied by predictive coding;
leaving as is only a DC coefficient in said DCT block detected to contain said DCT coefficient in said inter-macro block and transcoding all the other AC coefficients to “0”;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

13. A bitstream transcoding method comprising the steps of:
analyzing a data structure of a bitstream to be input to thereby detect whether a relevant DCT block contains a DCT coefficient in an intra-macro block not accompanied by predictive coding;
leaving as is only a DC coefficient in said DCT block detected to contain said DCT coefficient in said intra-macro block and transcoding all the other AC coefficients to “0”;
outputting said bitstream having a code quality thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

14. A bitstream transcoding method comprising the A steps of:
analyzing a data structure of a bitstream to be input to thereby detect whether a relevant DCT block contains a DCT coefficient in a macro block;
leaving as are only the first through N'th coefficients (N: natural number) in said DCT block detected to contain said DCT coefficient and transcoding all the other DCT coefficients to “0”;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

15. A bitstream transcoding method comprising the steps of:
analyzing a data structure of a bitstream to be input to thereby detect whether a macro block type indicates “performing of motion compensation and containing of a block having a DCT coefficient”;
transcoding all DCT coefficients in a macro block concerned in said detection to “0” and transcoding said macro block type to such a type that indicates “performing of motion compensation and having no DCT coefficient”;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

16. A bitstream transcoding method comprising the steps of:
analyzing a data structure of a bitstream to be input to thereby detect whether a macro block type indicates “performing of motion compensation, containing of a block having a DCT coefficient, and being a variation point in a quantization step”;
transcoding all DCT coefficients in a macro block concerned in said detection to “0” and transcoding said macro block type to such a type that indicates “performing of motion compensation and having no DCT coefficient”;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

17. A bitstream transcoding method comprising the steps of:
analyzing a data structure of a bitstream to be input to thereby detect whether a relevant DCT block contains a DCT coefficient of a chrominance signal in a macro block;
transcoding all DCT coefficients in said DCT block of said chrominance signal concerned in said detection to “0” and changing a coded block pattern correspondingly;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

18. A bitstream transcoding method comprising the steps of:
analyzing a data structure of a bitstream to be input to thereby detect whether a relevant DCT block contains a DCT coefficient of a chrominance signal in a macro block;
leaving as is only one “non-zero” coefficient encountered first in scanning in said DCT block containing said DCT coefficient of said luminance signal in a macro block corresponding to said DCT block of said chrominance signal concerned in said detection and transcoding all the other DCT coefficients to “0”;
transcoding all DCT coefficients in said DCT block of said chrominance signal concerned in said detection to “0” and changing a coded block pattern correspondingly;
outputting said bitstream having a code quantity thereof reduced by said transcoding step;
replacing an individual picture in said bitstream to be input with a dummy picture; and
outputting said bitstream having a code quantity reduced by said replacing step,
wherein the above-mentioned plurality of bitstream transcoding methods having different aspects is switched appropriately in configuration.

19. The bitstream transcoding method according to claim 11, wherein, in said step of switching the plurality of bitstream transcoding methods having different aspects, said plurality of bitstream transcoding methods is switched each time a picture not employing predictive coding is input.

20. The bitstream transcoding method according to claim 11, wherein, in said step of switching the plurality of bitstream transcoding methods having different aspects, said plurality of bitstream transcoding methods is switched each time a GOP header is input.

21. The bitstream transcoding method according to claim 11, wherein, in said step of switching the plurality of bitstream transcoding methods having different aspects, said plurality of bitstream transcoding methods is switched each time a picture not employing predictive coding is input and each time a GOP header is input.

22. A bitstream transcoding method comprising the steps of:
setting at level 1 such a case that performs the transcoding method according to claim 1 on a picture employing bilateral prediction;
setting at level 2 such a case that performs a transcoding method of replacing a picture employing bilateral prediction with a dummy picture;
setting at level 3 such a case that performs the transcoding method according to claim 1 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

23. A bitstream transcoding method comprising the steps of:
setting at level 1 such a case that performs the transcoding method according to claim 5 on a picture employing bilateral prediction;
setting at level 2 such a case that performs a transcoding method of replacing a picture employing bilateral prediction with a dummy picture;
setting at level 3 such a case that performs the transcoding method according to claim 5 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

24. A bitstream transcoding method comprising the steps of:
setting at level 1 such a case that performs the transcoding method according to claim 7 on a picture employing bilateral prediction;
setting at level 2 such a case that performs a transcoding method of replacing a picture employing bilateral prediction with a dummy picture;
setting at level 3 such a case that performs the transcoding method according to claim 7 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

25. A bitstream transcoding method comprising the steps of:
setting at level 1 such a case that performs the transcoding method according to claim 8 on a picture employing bilateral prediction;
setting at level 2 such a case that performs a transcoding method of replacing a picture employing bilateral prediction with a dummy picture;
setting at level 3 such a case that performs the transcoding method according to claim 8 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

26. A bitstream transcoding method comprising the steps of:
setting at level 1 such a case that performs the transcoding method according to claim 9 on a picture employing bilateral prediction;
setting at level 2 such a case that performs a transcoding method of replacing a picture employing bilateral prediction with a dummy picture;
setting at level 3 such a case that performs the transcoding method according to claim 9 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

27. A bitstream transcoding method comprising the steps of:
setting at level 1 such a case that performs the transcoding method according to claim 10 on a picture employing bilateral prediction;
setting at level 2 such a case that performs a transcoding method of replacing a picture employing bilateral prediction with a dummy picture;
setting at level 3 such a case that performs the transcoding method according to claim 10 on a picture employing forward prediction;
setting at level 4 such a case that performs a transcoding method of replacing a picture employing forward prediction with a dummy picture;
setting at level 5 such a case that performs a transcoding method of replacing a picture not employing predictive coding with a dummy picture at a predetermined rate;
detecting an instruction for switching said plurality of levels 1 through 5; and
switching said levels each time said switching instruction is received.

28. The bitstream transcoding method according to claim 22, wherein said step of switching said levels is performed each time a picture not employing predictive coding is input.

29. The bitstream transcoding method according to claim 22, wherein said step of switching said levels is performed each time a GOP header is input.

30. The bitstream transcoding method according to claim 22, wherein said step of switching said levels is performed each predetermined time interval.

31. The bitstream transcoding method according to claim 22, wherein at least any one of said plurality of levels is left as is to thereby remove any desired one or an any desired plurality of said levels remaining.

32. The bitstream transcoding method according to claim 1, wherein a subject bitstream contains an image signal coded according to the MPEG standard.

33. A bitstream transcoding apparatus comprising:
code detecting means for analyzing a data structure of an input bitstream; and
DCT coefficients reducing means for leaving as is at least one “non-zero” DCT coefficient of DCT coefficients in a DCT block of said input bitstream and transcoding all the other DCT coefficients to “0” based on a data structure analyzing result by said code detecting means.

34. A bitstream transcoding apparatus comprising:
code detecting means for analyzing a data structure of an input bitstream;
DCT coefficients reducing means for leaving as is at least one “non-zero” DCT coefficient of DCT coefficients in a DCT block of said input bitstream and transcoding all the other DCT coefficients to “0” based on a data structure analyzing result by said code detecting means; and
macro block type transcoding method for transcoding a macro block type of said input bitstream to such a macro block type that corresponds to a processing result by said DCT coefficients reducing means based on said data structure analyzing result by said code detecting means.

35. A bitstream transcoding apparatus comprising:
code detecting means for analyzing a data structure of an input bitstream;
DCT coefficients reducing means for leaving as is at least one “non-zero” DCT coefficient of DCT coefficients in a DCT block of said input bitstream and transcoding all the other DCT coefficients to “0” based on a data structure analyzing result by said code detecting means; and
coded block pattern transcoding method for transcoding a coded block pattern of said input bitstream to such a coded block pattern that corresponds to a processing result by said DCT coefficients reducing means based on said data structure analyzing result by said code detecting means.

36. A computer-readable recording medium for use in bitstream transcode recording a program for executing:
a procedure for analyzing a data structure of an input bitstream; and
a procedure for leaving as is at least one “non-zero” DCT coefficient of DCT coefficients in a DCT block of said input bitstream and transcoding all the other DCT coefficients to “0” based on said data structure analyzing result by said data structure analyzing procedure;

37. A computer-readable recording medium for use in bitstream transcode recording a program for executing:
a procedure for analyzing a data structure of an input bitstream;
a procedure for leaving as is at least one “non-zero” DCT coefficient of DCT coefficients in a DCT block of said input bitstream and transcoding all the other DCT coefficients to “0” based on said data structure analyzing result by said data structure analyzing procedure; and
a procedure for transcoding a macro block type of said input bitstream to such a macro block type that corresponds to a processing result by said DCT coefficient transcoding procedure based on said data structure analyzing result.

38. A computer-readable recording medium for use in bitstream transcode recording a program for executing:
a procedure for analyzing a data structure of an input bitstream;
a procedure for leaving as is at least one “non-zero” DCT coefficient of DCT coefficients in a DCT block of said input bitstream and transcoding all the other DCT coefficients to “0” based on said data structure analyzing result by said data structure analyzing procedure; and
a procedure for transcoding a coded block pattern of said input bitstream to such a coded block pattern that corresponds to a processing result by said DCT coefficient transcoding procedure based on said data structure analyzing result.
